(19) United States
(12) Patent Application Publication
(10) Pub. No.: US 2024/0169452 A1
(43) Pub. Date: May 23, 2024

(54) PREDICTING DAMAGE CAUSED BY FUNGAL INFECTION RELATING TO CROP PLANTS OF A PARTICULAR SPECIES

(71) Applicant: BASF SE, Ludwigshafen am Rhein (DE)

(72) Inventors: Frederick Craig STEVENSON, Calgary (CA); David WALDNER, Calgary (CA); Jeff DENYS, Mississauga (CA)

(21) Appl. No.: 18/282,602

(22) PCT Filed: Mar. 24, 2022
(86) PCT No.: PCT/EP2022/057729

§ 371 Date: Sep. 18, 2023

(30) Foreign Application Priority Data
Mar. 26, 2021 (EP) 21165393.6

(51) Int. Cl. G06Q 50/02

(52) U.S. Cl. CPC G06Q 50/02

(57) ABSTRACT

A computer predicts damage to crop plants (110) in a particular geographic area (100), caused by Sclerotinia fungi. The computer receives current condition data (202) in form of time-series, collected during a monitor interval. The current condition data (202) comprises plant data with an identifier of a particular crop plant species, the identifier of crop plants previously grown, and biomass data; as well as environmental with weather data and with soil moisture data. The computer processes the current condition data (202) by an artificial neural network (472), and provides predicted damage data (302). The artificial neural network (472) has previously being trained by a combination of historical condition data in the form of time-series for the particular geographic area (100) and historical damage data in form of expert annotations.

### TECHNICAL FIELD

In general, the disclosure relates to digital farming, and more in particular, relates to the prediction of damage for crop plants in relation to a potential fungal infection.

### BACKGROUND

In agriculture, there is a desire to harvest crop plants with an optimized yield. Environmental phenomena act on the objects on the agricultural fields differently. Much simplified, rain and sun let the plants grow, but if there is more rain than sun, fungi may show up and infect the plants.

The farmers or growers may apply chemical substances (i.e., agrochemical compounds), such as fertilizers to maximize the growth of the crop plant, or fungicides to keep infections at low scale. Efficient fungicide application requires exact timing (i.e., using a fungicide shortly before fungal spores develop into fungi) and suitable amounts (i.e., to destroy the spores or the fungi but nothing else).

However, the farmers face situations that may create a dilemma. Farmers not applying fungicides increase the risk that the plants get infected by fungi, but there is still a chance that fungal infection remains negligible (much simplified, if sunshine prevails over rain). The farmers may apply fungicides to an otherwise healthy plant. However, as fungicide application may pollute the environment, there is a preference to use fungicides only when fungal infection is expected with relatively high likelihood.

Over decades or even centuries, farmers have acquired comprehensive knowledge to consider environmental phenomena in finding suitable anti-fungi measures. It would be desired to have a formula that describes the cause-effect relation of fungal infection. Such a formula would have many variables. Rain and sun would only be prominent examples for such variables. However, such a formula is not available.

### SUMMARY

The crop plants grow in a particular geographic area, and particular fungi (such as Sclerotinia sclerotiorum) can damage these crop plants. In other words, there is an area-specific risk that fungal spores develop into fungi. The above-mentioned cause-effect formula is however not available.

The computer steps in here. It does not have the formula either, but it runs a neural network that approximates a relation between conditions and potential damage.

As the conditions are applicable to the area and to current plant growth (and for intended growth), they are current conditions.

The computer processes condition data that comprise data regarding rain and sun and that comprises much more: plant data and environmental data. Condition data is available in the form of time-series, usually starting at seed time. The computer can obtain condition data from a variety of data providers (that derive data from satellite images) and/or from the farmers.

Plant data describe the plants currently being grown in the particular geographic area (or intended for growing), by an identifier of the particular species of crop plants, the plants previously being grown, by identifier as well, and (optionally) biomass data for the crop plants currently being grown.

Environmental data that describe the environment of the particular geographic area, with weather data and soil moisture data.

The computer implements the approximate relation by a relatively large number of network weights. The network has previously being trained by a combination of condition data and by damage data that is available from previous growth cycles, or “historical data”.

Historical condition data is plant and environmental data from the past, and historical damage data represents damage that has occurred in the past.

Historical condition data and historical damage data are linked with each other.

Historical condition data are available as time-series (usually from seed time to harvest time) and historical damage data is available as expert annotations to the time-series. In that sense, the combination of historical condition data and historical damage data can be regarded as ground truth for training the network.

The computer receives data that describe the current conditions relating to the area and provides damage data as a prediction, for example a prediction that indicates the percentages of damaged crop plants to be expected at harvest time.

As the operation time of the computer (including the reception of data) is negligible short, the farmer can obtain a prediction at any time (before harvest). Based on the prediction, the farmer can make an informative decision to apply fungicides or not.

More in detail, the computer is adapted to predict damage for the particular area by running an artificial neural network (ANN) and thereby executes a computer-implemented method. The computer receiving current condition data in form of time-series. The current condition data relates to the particular geographic area and is being collected during a monitor interval. The monitor interval has a start time point and extends to to a present time point, that means to a time point shortly before run-time of the computer. The monitor interval can comprise at least the time point when the crop plants started growing during a particular growth cycle. Alternatively, the crop plants are not yet grown, there is merely the intention to grow them.

The computer processes the current condition data by an artificial neural network implementing a model that is a multilayer perceptron.

The artificial neural network has been trained previously by a combination of historical condition data—in the form of time-series for the particular geographic area—and historical damage data in form of expert annotations.

A computer-implemented method is provided to predict damage of crop plants of a particular species. The damage is caused by Sclerotinia sp. fungi. The crop plants grow in a particular geographic area.

In a step receiving current condition data in form of time-series, the computer receives current condition data that relate to the particular geographic area and that are collected during a monitor interval from a start time point to a present time point. The current condition data comprise plant data that describe the plants growing (or to be grown) in the particular geographic area by a species identifier of the particular species of crop plants, and the number of occurrences of the crop plant in a previous interval. The current condition data further comprise environmental data that describe the environment of the particular geographic area (for example with weather data and soil moisture data).

In a step processing the current condition data by an artificial neural network, the computer provides predicted damage data. The artificial neural network is obtainable by previously training it by processing historical condition data in the form of time-series in combination with historical damage data in form of expert annotations, or in combination with historical damage data in form of sensor readings.

Optionally, the historic condition data comprises crop cycle data. Historic crop cycle data relates to the types of crops that have been grown in past seasons.

In other words, the method according to the present disclosure may generate a probability value for disease and damage of plants, which takes into account historical data on the crop cycle. Data on the crop cycle may also be called data on crop rotation. The crop cycle is indicative of the presence of Sclerotinia spores since repeated growing seasons of the same crop, e.g. canola, vastly increase the chances that Sclerotinia spores are present in the soil. Sclerotinia may stay in the soil during winter, and then may form apothecia during spring to generate spores that infect flowering plants. It has been found that crop cycle information on previous growing periods is crucial to predict a risk for Sclerotinia spores being present in a specific area.

Optionally, the environment data comprises the air temperature data.

Optionally, the environment data further comprises at least one of soil moisture data, relative air humidity data, wind speed data, and precipitation data. It has been found that especially soil moisture has an important influence on a risk for Sclerotinia spores being present in a specific area.

Optionally, the plant data further comprises biomass data.

Optionally, the monitor interval can comprise at least the time point when the crop plants started growing during a particular growth cycle.

Optionally, the monitor interval can end before the time point of intended seed of the crop plant.

Optionally, receiving current condition data can comprise to receive the number of occurrences of the crop plant in a previous interval together with an identification of occurrences of crop plants for different species.

Optionally, receiving current condition data can comprise to receive biomass data for the crop plants currently being grown.

Optionally, the crop plants are selected from the group consisting of: Brassica napus Canola, Helianthus annuus, Fabaceae sp., Glycine max, Lens culinaris, and Pisum sativum.

Optionally, the artificial neural network is a model that is a multilayer perceptron.

Optionally, the predicted damage data can be provided as the ratio between the number of crop plants expected to be infected by that Sclerotinia sp. fungi in the particular geographic area shortly before harvest, over the number of crop plants grown in the particular geographic area during a growth cycle.

Optionally, receiving current condition data in form of time-series can comprise to receive the time-series with equidistant time-divisions that have a value between and days.

Optionally, receiving current condition data in form of time-series can comprise to receive the time-series with equidistance time-divisions that are weeks.

Optionally, receiving current condition data in form of time-series can comprise to receive the time-series in the first order difference.

Optionally, receiving current condition data in form of time-series can further comprise to receive real damage data that describe damage that has really occurred.

Optionally, receiving current condition data in form of time-series can further comprise to receive use data that describe the use intensity of a particular chemical compound on the particular geographic area.

Preferably, the condition data, especially current condition data, is received from satellite images.

In an example, satellite imaging is collected over repetitive periods of seven days. Only data of clear, cloudless days is used. Within a period of seven consecutive days, there is a high probability that satellite images can be captured on a cloudless day. Thus, clear satellite images of high resolution and high quality are available. If for each period of seven consecutive days one satellite image is used for providing condition data, an overall temporal resolution of 7 days is realized.

A computer program product that—when loaded into a memory of a computer and being executed by at least one processor of the computer causes the computer to perform the method steps.

A computer system can comprise a plurality of function modules which, when executed by the computer system, perform the steps of the computer-implemented method.

### BRIEF DESCRIPTION OF THE DRAWINGS

FIG. 1 is an overview matrix for a crop plant in three consecutive growth stages in three scenarios;

FIG. 2 illustrates a computer that is adapted to predict damage for crop plants that are growing in a particular area;

FIG. 3 illustrates a yield-over-time diagram with particular points in time;

FIG. 4 illustrates current condition data and historical condition data, in view of time;

FIG. 5 illustrates the training of the network in general;

FIG. 6 illustrates simplified code for an implementation example by that the neural network performs training;

FIG. 7 illustrates simplified code for the implementation example by that neural network performs prediction;

FIG. 8 illustrates a simplified topology for the neural network of FIGS. 6-7;

FIG. 9 illustrates an overview to different importance for different current condition data; and

FIG. 10 illustrates a generic computer system by that a system for prediction can be implemented.

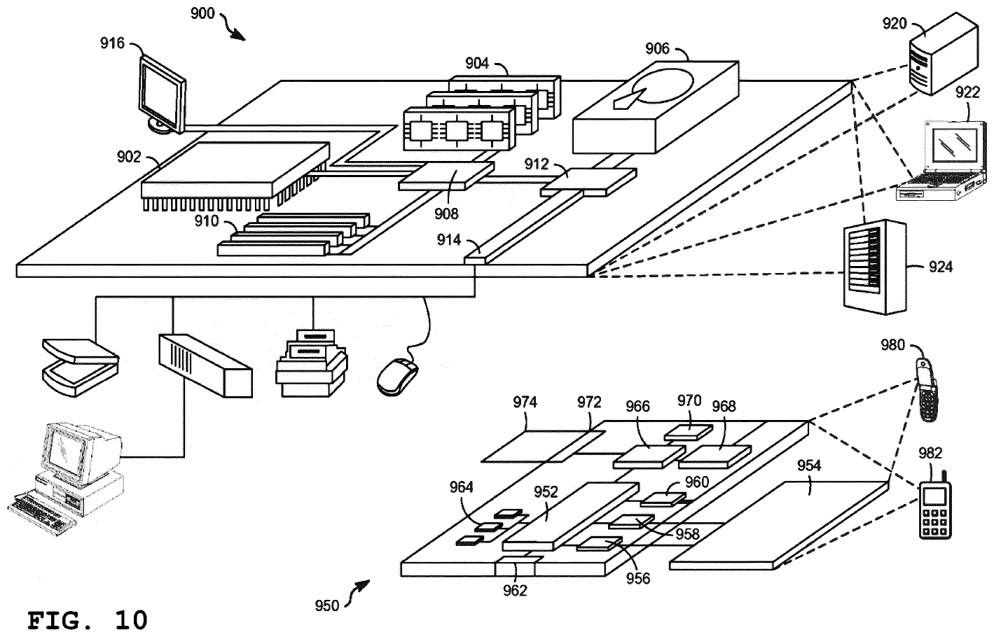

### DETAILED DESCRIPTION

Writing Conventions

The description uses plural without articles for non-countable objects such as fungi or fungal spores. The term “crop plant” is short for “crop plant” and for the alternative term “useful plant”.

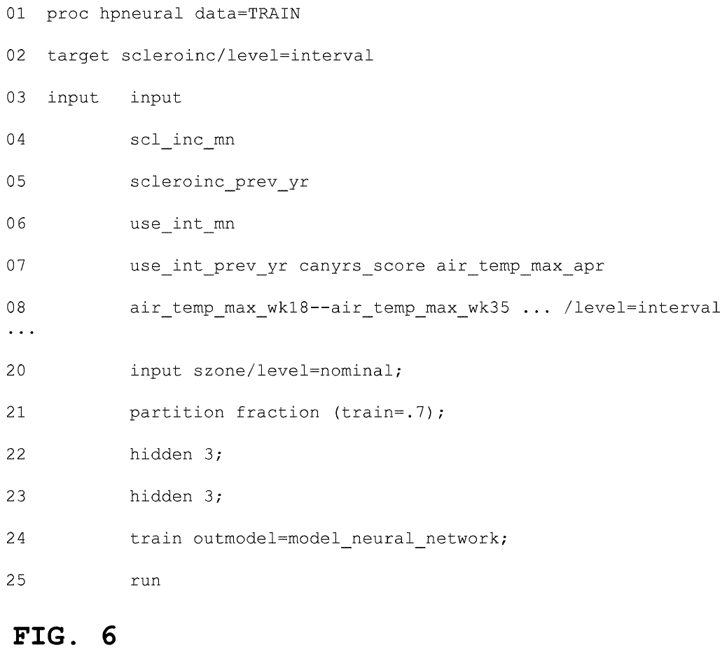

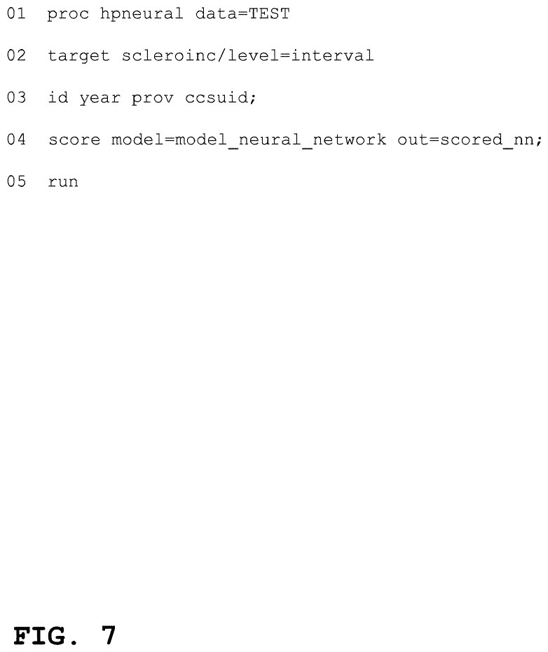

As the operation of an artificial neural network (ANN) can be differentiated into two phases, TRAINING und PREDICTION, the description occasionally indicates the phases by references **1 and **2, respectively. In the art, the second phase **2 is also called “testing phase” or “scoring phase” (especially in the example of FIGS. 6-7).

For simplicity, the term “particular geographic area” is shortened to “area”.

The phrase “fungal infection incidence” stands for a percentage of leaves of a given crop plant showing symptoms of fungal infection. Assessment is known by those skilled in the art and typically made in comparison with leaves of control plants (such as non-treated crop plants).

In view of the above mentioned cause-effect relation of fungal infection, the description differentiates between “condition data” that is data related to the causes of infection, and “damage data” that is data describing the effect (such as the fungal infection).

Figures may follow such differentiation by showing condition data on the left side and showing damage data on the right sides.

Locations are referred to as “geographical area” and “geographical region” (or “area” and “region” in short). Areas belong to regions.

Overview to Plant Growth and to the Prediction of Damage

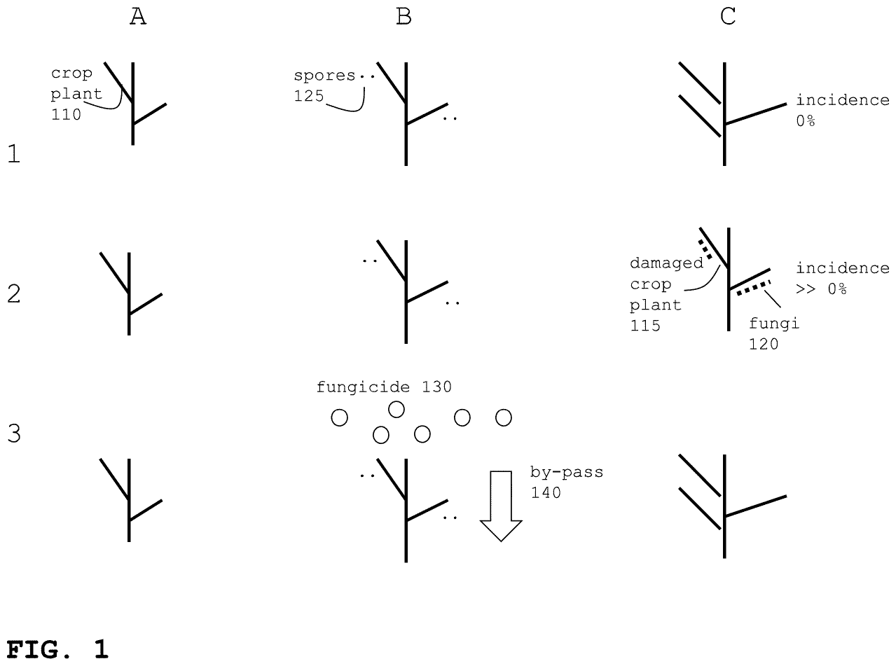

FIG. 1 is an overview matrix for crop plant 110 in three consecutive growth stages A, B, and C in three scenarios 1, 2 and 3. From left to right, the figure illustrates, in columns stage A in that the plant is young and healthy, stage B in that the plant is growing (e.g., early flowering), and stage C in that the plant becomes ready for harvest.

Very roughly, the stages may correspond to the seasons: stage A to spring, stage B to summer, stage C to autumn. Stage sequence ABC stands for a particular growth cycle (i.e., from seed to harvest, usually in less than half a year). As the computer calculates with time divisions (such as weeks or days) but not with stages, the duration of the stages and the time for state transitions (A to B, B to C) are not further discussed herein.

For convenience, the description assumes to have only one growth cycle ABC per calendar year. The description further assumes that the plants grow in the Northern hemisphere. The person of skill in the art can easily introduce some adaptations for the Southern hemisphere. For example, the new year arrives during the growth cycle, so that the computer processes data with a year count that changes during growth.

The skilled person can transfer the teachings herein to the Southern hemisphere (for example, year change in summer during growth) easily. Also, there can be multiple cycles per year.

The figure illustrates the potential yield of the plant by different plant symbols. The smaller symbols (with 2 leaves) stand for plants with smaller biomass (e.g., A1). The larger symbols (with 3 leaves) stand for plants with larger biomass (e.g., C1).

Crop plant 110 belongs to a particular plant species, and fungi 120 (that affect the plant) belong to a particular fungi species. In the following, the description frequently refers to the example of the following plant/fungi pair: the plant is canola (Brassica napus Canola, EPPO code: BRSNC), and fungi are Sclerotinia sp. (such as Sclerotinia sclerotiorum, EPPO code SCLESC).

Although Canola here serves as an example, the crop plant can belong to other species, such as Brassica napus Canola, Helianthus annuus, Fabaceae sp., Glycine max, Lens culinaris, or Pisum sativum.

In scenario 1 (row at the top), the plant is growing naturally during A1 and B1. The plant might catch some fungal spores 125 (illustrated by dots) more or less at any stage. The environmental conditions (at least during A1 and B1) are such that fungal spores do not develop into fungi. Therefore, the plant remains healthy and reaches its usual size in C1. No fungicide is applied. This is the ideal scenario.

In scenario 2 (row in the middle), the plant is growing, but during B2 it also catches spores. Due to certain conditions (before A2, during A2 and during B2), spores develop over time into fungi 120 (dotted lines). In other words, the plant gets infected by fungi. Consequently, the plant keeps its size in C2 (and does not grow further), but fungi 120 grow as well and may damage the plant. Such a situation should be avoided. The plant is illustrated as damaged crop plant 115 (in C2).

In scenario 3 (row below), the farmer treats the plant by applying appropriate fungicide 130 during B2. The figure illustrates the fungicide by drops being sprayed to the plant. The plant reaches its usual size in C3. This is not ideal, because the anti-fungi substance (i.e., an agrochemical compound in the function of a fungicide) has been applied. As the arrow in B3 symbolizes, surplus fungicide 140 does not reach the plant and potentially pollutes the environment (e.g., by flowing to the soil). In other words, there is a bypass into the environment. Such a bypass is not desired.

The illustration is symbolic. In more realistic scenarios, plants may reach their normal size, but parts of the plants may be affected by fungi. But in many cases, there is a yield loss: the plants are harvested (in C2, C3) with less biomass than they could have ideally (in C1).

The arrival of fungal spores 125 can't be avoided. Although the figure illustrates spores in all scenarios, spores 125 may not arrive at all, or may arrive in insignificant numbers only. Even worse, it is well known that spores are relatively tiny and very difficult to detect (at least not by equipment that is usually available to farmers).

During stage B, the farmer inspects “rain and sun” during A and B (and many other observations) and estimates if fungi develop (as in C2) or not (as in C1). Based on the estimation, the farmer decides on applying fungicide (and on the amount, timing etc. leading to C3) or not (leading to C1 or C2). However, the estimation may not be accurate. Further, different farmers may have different experience and may decide differently.

During stage B (and occasionally during stage C), the computer assists the farmer by processing data that describe the conditions under that the plants grow. Such data is currently available for A and B.

The data—current condition data—represents the mentioned conditions and is applicable to the particular geographic area (i.e., the locus in which crop plants 110 grow in their normal habitat), or “area” in the following. The computer operates during stage B and makes a prediction into stage C, for that area. The computer provides the prediction as predicted damage data.

The figure labels predicted data by the term “incidence”. It can be a percentage standing for the ratio Z/Y between the number Z of damaged crop plants 115 (expected to be infected by fungi 120 in the area shortly before harvest) over the number Y of crop plants 110 grown in the area during the growth cycle. In that sense, predicted damage data indicates a probability value (or likelihood value) for damage. In the figure, this value is substantially zero percent in C1, and larger than zero in C2. For convenience, the description also refers to the Z/Y ratio also as incidence value. In connection with FIGS. 6-7, the description will refer to that value in an example as “Sclerotinia incidence”.

Based on that prediction, the farmer can decide. He will not apply fungicides for incidence values below a threshold (e.g., 20%) but will apply them for higher incidence values.

A further indicator could be a modified Z/Y ratio. As Z will not jump from zero to its final value (Z at harvest time), the number of damaged plants will gradually increase, from day to day or from week to week. In other words, predicted damage data can be provided as an incidence level (INCIDENCE_LEVEL) defined as the number of plants (N_INFECT) being infected by that fungi in the particular geographic area during a particular time interval (T_INTERVAL at the end of C) over the product of the time interval T_INTERVAL with the number of plants (N_PLANTS) located in the particular geographic area:

INCIDENCE_LEVEL=N_INFECT/(T_INTERVAL*N_PLANTS).

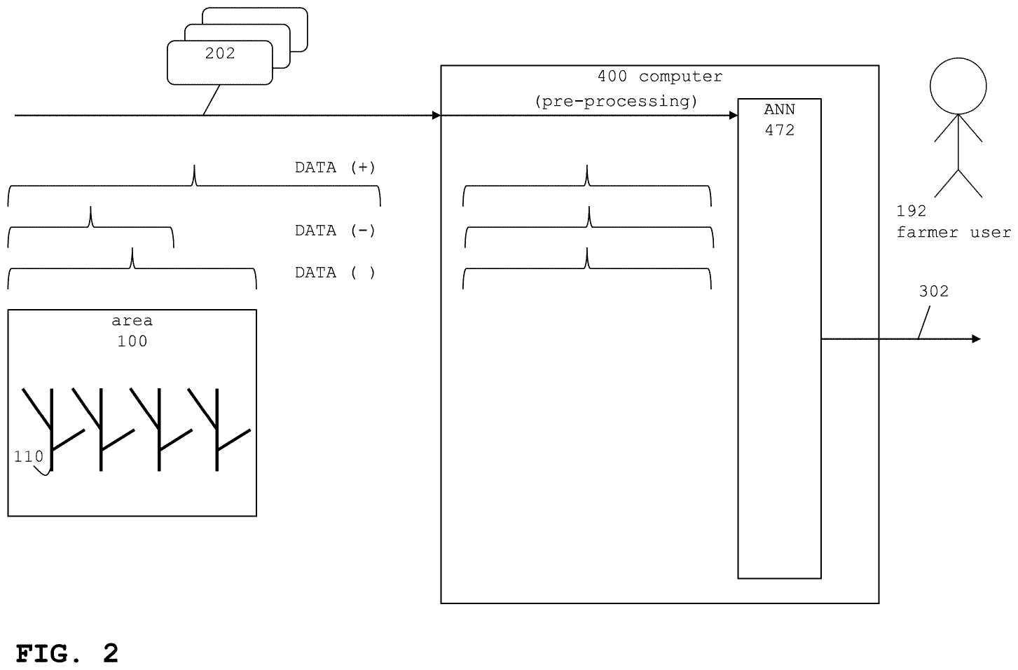

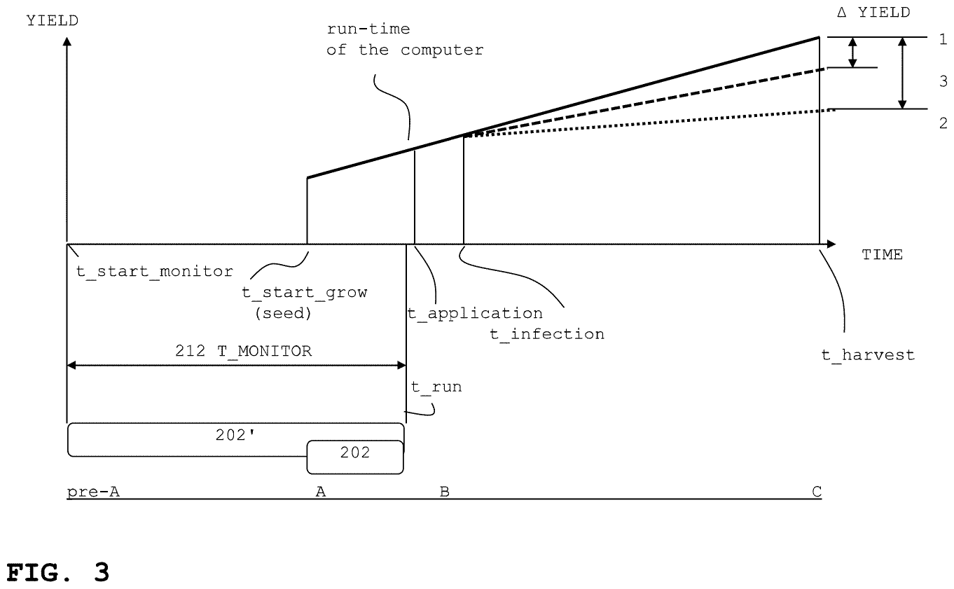

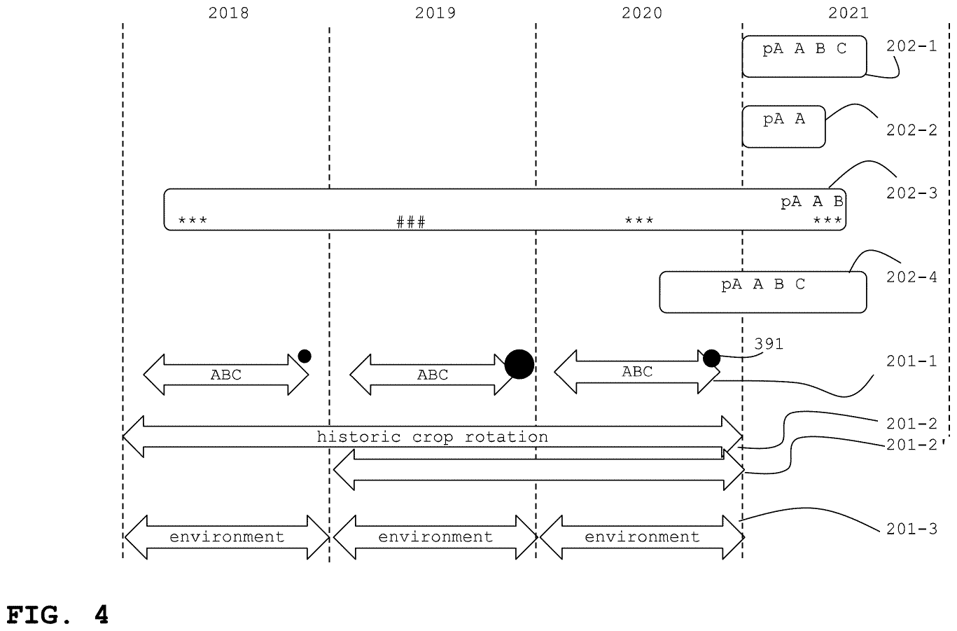

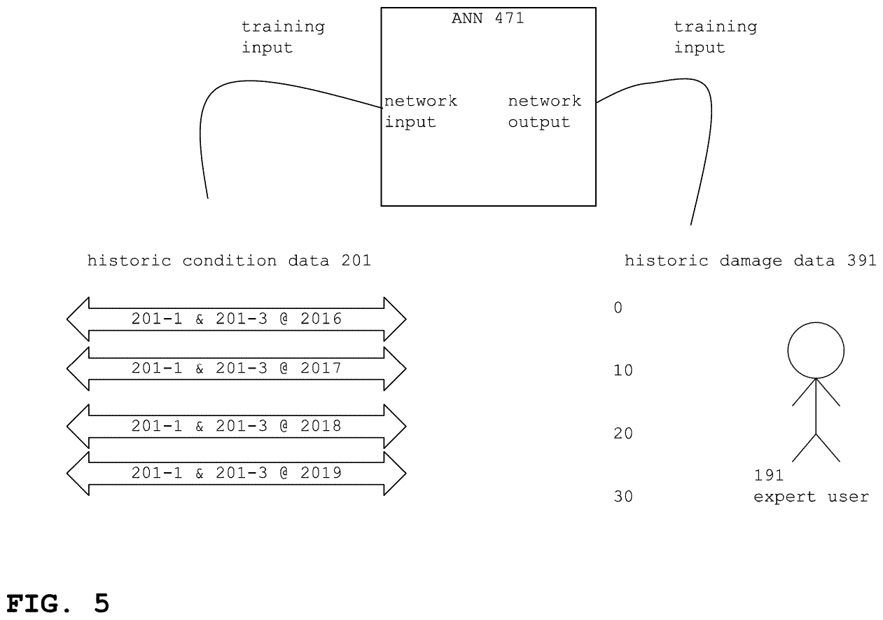

The description will now explain the approach to obtain such predicted damage data. Thereby the description will explain structure and function of the computer (mostly in FIG. 2), explain time points during the growth cycle ABC with more detail (FIG. 3), expand the discussion of the timing aspects into historical condition data (FIG. 4), explain the use of historical condition data and expert annotations of historical damage data during training (FIG. 5), and conclude with implementation examples for the network (FIGS. 6-7).

Computer System

FIG. 2 illustrates computer 400 (or computer system) that is adapted to predict damage for crop plants 110 that are growing in a particular geographic area 100.

Area 100 defines the prediction granularity in terms of location. As computer 400 makes the damage prediction relating to crop plants 110 in area 100, the prediction is applicable for substantially all locations within area 100. The computer processes data that is related to the area 100. It is, however not required that crop plants 110 occupy area 100 completely.

Area 100 can have physical borders. For example, it can be a particular agricultural field surrounded by farm tracks or the like.

Area 100 can also be a fraction of an overall region in that crop plants (of a particular plant species) are cultivated. The skilled person can identify the fraction arbitrarily. In that sense, area 100 would be defined by “virtual” borders.

Since the data (to be processed) can be available in a granularity that is defined by administrative areas, a particular area 100 can coincide with a particular administrative area (or administrative subdivision). Using such data is convenient, because data can easily be accompanied by metadata that is available for administration (such as postal codes, area identification codes, lot or section numbers, or the like).

To give an example for Canada, an area can be a municipality, and in many cases it would be a so-called rural municipality (RM). To take an example for Germany, the area could be a municipality such as “Limburgerhof”. This particular municipality is approximately 9 square kilometers large, has a postal code, and shows up in weather forecast data. Since there are houses, streets and the like, plants do not grow in Limburgerhof everywhere.

Or, area 100 can be a rectangle-shaped fraction in that the crop plants 110 grow.

Conveniently, a larger plant-growing region can be divided into a grid. Area 100 can be a square-shaped grid element. The side-lengths within the grid can be standardized. A convenient side-length is between 5 and 15 kilometers. The example implementation (explained below) uses a 10 kilometer grid. Within a grid, areas can easily be identified, not only by geographic coordinates for the center of the square but also by grid coordinates.

Crop plants 110 belong to the same particular plant species (such as in the above-mentioned example EPPO: BRSNC).

In the following, the description occasionally refers to the Canola/Sclerotinia pair, and identifies damage data as Sclerotinia incidence, or “scleroinc” in short.

As used herein, current condition data 202 is data related to the conditions that may influence the particular growth cycle ABC ongoing in area 100. Current condition data 202 comprises—at least—plant data that describe the plants in the area by a species identifier (or “plant identifier”, for crops currently being grown, and for crops previously grown), as well as (optional) biomass data for the crop plants currently being grown. Current condition data also comprises environmental data, with weather data and soil moisture data.

Computer 400 runs a prediction model (such as network 472) that has been trained earlier (being network 471, cf. FIG. 5). In other words, network 472 is a pre-trained network. The description will explain training in connection with FIG. 5.

FIG. 2 concentrates on current condition data 202 that the computer receives, and on predicted damage data 302 that the computer provides (e.g., in form of incidence values or similar values as explained for FIG. 1).

The computer receives current condition data 202, and provides predicted damage data 302 during the run-time of model 472 (i.e., that is “testing time”, after training).

The skilled person can handle data logistics (such as communicating data to the computer, storing data in databases or the like) without the need of further explanation herein.

Current condition data 202 to computer system 400 can be differentiated in terms of modality, and time. Such a differentiation is convenient for explanation.

Regarding the modality, current condition data 202 can be differentiated as follows: Plant data describe the plants growing in geographic area 100 (currently growing or growing in the future). Plant data comprises an identifier of the plant species currently being grown (in current growth cycle ABC) or having been grown in the past (e.g., identifier for previous crop cycles, the number of consecutive growth cycles of the plants). Plant data can also describe the process of growth within the cycle. The skilled person can use standardized conventions for stages that are more accurate than A, B, or C.

Optionally, plant data also comprises biomass data (of the plant currently being grown).

Environmental data describe the environment of geographic area 100, such as weather data, soil moisture data, and other.

Optionally, real damage data describe damage that has really occurred (during ABC, on area 100), conveniently as incidence (cf. Z/Y). Real damage data can have the format of predicted damage data 302 (explained below). Real damage data can be provided by annotations from damage experts. These experts usually survey damages for geographical regions that include many individual areas 100 (e.g., a region being a province in Canada or a Bundesland in Germany). Farmers would usually not work as damage experts. Real damage data at the input of computer 400 is data obtained by measurements (not by prediction).

Optionally, use data describe the use intensity (or the application intensity) of a particular chemical compound on area 100 (such as fungicide 130 in FIG. 1, B3 for an example). Use data can indicate a volume amount of a particular agricultural compound per square meter.

Computer 400 does not have to receive current condition data 202 in all modalities.

Computer 400 receives real damage data and use data optionally.

Current condition data 202 comprises one or more parameters. The parameters are specific to the modality. To take environmental data as an example, weather data has parameters such as air temperature, relative humidity, wind speed, sunshine duration, dew point, cloud coverage, precipitation (also accumulated values thereof), air temperature, long wave radiation, and others.

Parameters can be differentiated by minimum values, maximum values, average values, median values, etc.

The description will turn to an implementation example, and for simplicity it will focus on four examples of current condition data 202: crop history and biomass (examples for plant data), soil moisture, and weather data (examples for environmental data).

Regarding the time, computer system 400 can receive current condition data 202 in the form of time-series. (Not all data is available in time-series). A time-series is a collection of data values (V_1, V_2, . . . V_N) (for a particular parameter) applicable for consecutive points in time (t_1, t_2 . . . t_N). The temporal distance between consecutive time points (t_n and t_(n+1)) is substantially equidistant. To stay with the example of weather data, a time-series for the parameter temperature could be notated (temp_t_1, temp_t_2, temp_t_3 . . . temp_n)=(10, 11, 12, 10, 9, 8, 10, . . . ) with temperature values (in degrees Celsius) for consecutive days or weeks (“temp” instead of “V”).

The computer can also differentiate temporal granularity of current condition data 202 by start time points and by end time points (of the time-series). A convenient notation uses double-dashes (cf. the implementation examples of FIGS. 6-7). For example, “air_temp_max_wk18-air_temp_max_wk35” stands for the time-series with the maximal air temperature values measured for the 22 weeks from week 18 to week 35. The person of skill in the art can apply other notations.

The computer receives current condition data 202 during a particular growth cycle ABC (cf. FIG. 1), with the start time points being early in the cycle (cf. column A, or earlier), or even before the cycle starts, and applicable for the particular growth cycle. For convenience, current condition data 202 is symbolized by round-shaped rectangles.

In time-series, the interval (temporal distance) between consecutive time points is selected according to constraints in view of the output (i.e., to predict damage relating to crop plants). In other words, the timing accuracy is adapted to the output. Some aspects are explained in the following, in view of the modality.

Plant data changes slowly. The particular plant species remains unchanged (during ABC). The computer can receive the identification of the species (by plant identifiers, or species identifiers) and can receive an indication if A, B or C applies.

The environment can change within a minute (e.g., it starts raining) but the description assumes that fungi will react to changes within a much larger time frame, measured in days or weeks.

As it takes the farmer some hours to prepare the use of compounds (such as applying fungicides), use data is usually available at a granularity of days and the farmer can only react to damage data in such as relatively long time.

In other words, the modality sets the clock. Convenient time divisions (i.e., interval) can be hours, days, week, 10-day-periods or the like. The description uses the time-division “week” by way of example.

The run-time of computer 400 is negligibly short (i.e., much shorter than an hour).

Regarding location or space, computer system 400 can receive current condition data 202 in different spatial granularities. DATA (+) stands for data 202 available for larger regions that include area 100 (e.g., for a province or other administrative region, in that area 100 is located). DATA (−) stands for data 202 available for a part of area 100 only. Extrapolating is possible. For example, the temperature is measured for the center of area 100 but assumed to be the same all over area 100. Other approaches to fill in missing data can be applied as well, among them kriging (also Empirical Bayesian Kriging) and/or regression analysis. Such approaches are well-known in the art. DATA ( ) stands for data 202 that just fits to area 100.

Data Examples and Data Sources

Current condition data 202 can be obtained from a variety of sources, such as for example by remote sensing (satellite, airplane, unmanned aerial vehicle) and the person of skill in the art can arrange that. The description therefore refers to examples.

Weather data is available for at least every day, (even as forecast for some days in the future). The person of skill in the art can connect computer 400 to sources (or providers) to obtain such weather data. A commercial data provider is, for example, DTN, Burnsville, Minnesota, USA, frequently called DTN/ClearAg.

Soil moisture data is available on a daily base as well.

The crop type (species identifier) is an example for plant data. Looking at the granularity, the crop type can be defined as “oil seed rape”, but there is no need differentiate sub-species. It can be provided by computers that process satellite data.

Biomass data is available in various formats, such as in the form of a composite Normalized Difference Vegetation Index (NDVI) well known in the art. For example, the raw data comes from a satellite (e.g., from MODIS images) and NDVI can be calculated at a 250 square meter resolution on a daily time-stamp. In terms of MODIS, such a resolution is also called “pixel”. MODIS stands for Moderate Resolution Imaging Spectroradiometer, and is provided by the National Aeronautics and Space Administration (NASA).

As data is occasionally missing for some point in time, replacement data can be calculated. For example, for the implementation explained below, the biomass data is down-sampled to average values per week (or similar composite values). This accommodates situations where data is not available when clouds prevent the satellites to obtain data.

This approach also saves computation resources

Preprocessing Data

As illustrated in FIG. 2, current condition data 202 does not have to reach network 472 directly. The person of skill in the art will be able to pre-process raw data, especially to accommodate granularity transitions DATA (+) to DATA ( ), DATA (−) to DATA ( ).

Preprocessing techniques are available and well-known in the art. For example, extrapolating (already mentioned for space) can be applied to time as well.

Further, pre-processing time-series data is possible to obtain additional data to process. For example, differential values V_n−V_(n−1) indicate the change of a value between t_(n−1) and t_n. Such a derived time series is known in the art by terms such as “first order difference time-series”. Deriving the difference to predecessor values is convenient, but (n−2), (n−3) differences are also possible to apply.

For example, “bio_wk19_diff” indicate the change in biomass from week 18 to week 19 (i.e., bio_wk19_diff=bio_wk19−bio_wk_18). In an ideal situation, the biomass constantly rises (cf. row 1 in FIG. 1) and the difference value would be positive.

But the arrival of fungi (and other effects) may stop growth or even reverse it (negative differential value). Calculating the differential values is similar to calculating the derivative of a function.

Predicted Damage Data at the Output of the Network

Predicted damage data 302 from computer 400 is available to farmer user 192.

Optionally, predicted damage data 302 can be also differentiated in terms of modality and time as well. However, there is less complexity as with current condition data 202.

The spatial granularity is that of area 100 (e.g., predicted damage data 302 is applicable to area 100 as a whole, without differentiating sub-areas). The temporal granularity has two aspects: predicted damage data 302 becomes available at run-time of computer 400 (i.e., t_run explained below with FIG. 3) but indicates damage estimated for a time shortly before harvest. Depending on the training (cf. FIG. 5), the estimation could alternatively or additionally be provided for time points ahead of harvest (e.g., between t_run and t_harvest).

The operation of network 472 can be repeated periodically (t_run distributed to different time points, for example every week). As more current condition data 202 becomes available over time (from t_run to t_harvest), the accuracy of predicted damage data 302 rises.

Model Run by the Computer

While the above-mentioned complicated formula for the effect relation of fungal infection is not available, network 472 approximates a relation between current condition data 202 at its input and predicted damage data 302 at its output. Network 472 has been trained by historical condition data and by expert annotations (that are related to the historical data). Network 472 can be implemented by a variety of structures, such as a multilayer perceptron (cf. the example implementation in FIGS. 6-7) or as a random forest model. Since the network 472 provides predicted damage data 302 as a numerical value (such as the percentage explained above), it can be considered as a regression network.

Time Points and Intervals

FIG. 3 illustrates a yield-over-time diagram with particular points in time. FIG. 3 repeats the growth cycle with stages A, B and C from FIG. 1 but defines stage pre-A as an additional interval.

The time points can be explained in view of the above-mentioned time division.

Conveniently, time points can identify the division of a year into calendar weeks. Calendar weeks are usually numbered from week_1 to week_52 (or “wk01” to “wk52”). Dividing the time to other periods, such as 10 days is possible as well. The time-line is simplified to a continuous line, but a formal discrete time division applies. Examples are given in calendar weeks.

To illustrate this further, fungi will conquer the field (and damage the crop plants over an interval that would be measured in weeks). It takes the farmers some time (in the magnitude of hours, or days) to prepare the application of fungicides. Therefore, the time-division “week” corresponds to the duration by that the fungi usually develop and to the time it takes the farmers to combat them.

Time point “t_start_monitor” is the first time point for that current condition data 202 is available. In a particular growth cycle, this is usually the time point from when conditions can influence the growth of the plant, and of fungi as well. The figure illustrates t_start_monitor for the current conditions by a round-shaped rectangle 202′. Time point t_start_monitor coincides with the monitor interval T_MONITOR.

For example, t_start_monitor could be week_1 (or January 1, northern hemisphere) and—by way of simplified example—the data could indicate if the soil was frozen or not at that day.

In other implementations, some of the current condition data may go back in time even by a couple of years, for example by indicating the crop rotation (cf. FIG. 4, 202-3).

Time point t_start_growth indicates when the plants start growing (stage A starts from the seed), for example in week_15. In embodiments, current condition data 202 is collected from that point in time onwards, as illustrated by the smaller rectangle.

Time point t_run indicates the time when computer 400 performs the method and provides the prediction (cf. predicted damage data 302 at the output). In other words, t_run indicates the run-time of the method. t_run can be considered as the point in time when the computer operates (trained network 472, cf. FIG. 2).

The actual operation (from receiving input data to providing output data) is usually an interval of a few minutes (in that the computer is operating). Since the computer uses environmental data, monitoring must be performed before operating the computer (i.e., t_start_monitor<t_run). Current condition data 202 is available until t_run. Therefore, the interval T_MONITOR ends at t_run. Of course, current condition data can be collected from t_run onwards, but would go into an updated prediction.

Time point t_run also marks the time when predicted damage data 302 becomes available (from network 472). As explained above, the availability of data 302 at t_run does not necessarily mean that the damage has already occurred. The computer provides a prediction to a time point shortly before harvest, or to a different point in time (in the future, before harvest).

Time point t_application indicates the application of the anti-fungi substance. The illustration is simplified. There could be a time window for applying the fungicide. There can be multiple points in time. t_application can follow t_run almost immediately and is determined by the time it takes to prepare the application (filling the sprayer tank with fungicide etc.). Of course, applying fungicide is not required in all cases (e.g., for predicted damage data 302 below a threshold condition).

Time point t_infection marks the point in time when fungi appear the first time on the plant. The figure gives t_infection for completeness of explanation. Of course, under some environmental conditions, infections do not occur. There is an assumption that fungi will be destroyed by the fungicide (cf. scenario 3 in FIG. 1). t_infection also marks the time for that the plants may develop in the different scenarios of FIG. 1 (scenario 1 leading to the maximal yield, scenario 2 leading to minimal yield, and scenario 3 with the best-possible yield.) Of course, the yield-over-time is given schematically. Data relating the infection would be real damage data.

Time point t_harvest marks the time shorty before harvest (cf. C). The illustration uses t_harvest to discuss the yield (and the loss of yield due to infection). The skilled reader understand that harvesting may take a couple of time divisions (i.e., a couple of days).

Time point t_harvest also marks the point in time for that the computer made the prediction of data 302. The description refers to “shortly before harvest time” simply to enhance plausibility: the Z/Y ratio applies to plant not yet harvested.

Ongoing Operation

The operation can be repeated periodically. A repetition period can coincide with the period by that input data updates are completed. For example, as weather data and other data is available on a daily base, the computer can perform the prediction every day.

It is however suitable to run the computer on a weekly basis (i.e., the longest interval for data availability) because the farmer can still react to predicted fungi infection in a timely fashion.

Current and Historical Condition Data

FIG. 4 illustrates current condition data 202 in view of time by rectangles with round corners, and further illustrates historical condition data 201 by large arrow symbols. For convenience, the computer should operate in the year 2021 and should predict damage for plants growing in that year 2021. Other years (2020, 2019, 2018 and other years) provide historical condition data 201.

Current condition data 202-1 is an example for data available at the end of the growth cycle (in 2021) and comprises data before seed (prA, for example from Jan. 1, 2021) and data for the complete cycle ABC.

Current condition data 202-2 is an example for data available for the beginning of the cycle only (for example, prA and A, but not B or C). Such insufficient data is realistic.

Current condition data 202-3 is an example for crop rotation. This belongs to the modality of plant data. Stage A starts in spring 2021, but data is available that indicates that the particular field was used for plants for species canola in 2018, for other species in 2019, again for canola in 2020, and is currently 2021 used to cultivate canola. Examples for other species comprise wheat or the like.

In other words, the network can receive current condition data by receiving the number of occurrences of the crop plant in a previous interval (such as in the past two or three years) together with an identification of occurrences of crop plants for different species. Such an identification of different crop does not have to specify these crops. Simplified and again with the Canola example, the 3-year-interval has an occurrence number of 2 (i.e., 2 Canola years in 3 years total).

Current condition data 202-4 is an example for the availability of data that describe the autumn and winter seasons before seed (of a particular cycle ABC, growth data).

Again, and in view of the above definition of current condition data 202, data 202-1 to 202-4 is related to area 100.

Historical Condition Data

The description now gradually turns to the description of the training, but stays with FIG. 4. During training, the computer receives historical condition data 201 from a database (or equivalent storage). With a few theoretical exceptions, historical condition data 201 have been obtained before the particular growth cycle. Historical condition data 201 is used for training (cf. FIG. 5).

Historical condition data 201 can have the same modalities of growth data (such as being plant data, environmental data, real damage data, use data), and data 201 can be preprocessed (for example DATA (+)(−) to ( )). Also, historical condition data 201 can be available in time-series.

It is even possible to convert current condition data 202 into historical condition data 201 once a growth cycle ABC is over.

There are two points that deserve further explanation. (i) Historical condition data 201 is not necessarily related to particular area 100 in all aspects. For example, historical condition data 201 can be real damage data for an area that is not identical with area 100. Real damage data may only be available for a neighboring area. Or, historical condition data 201 can be use data (i.e., data regarding the application of fungicides in past years), but not for that particular area 100. (ii) Condition data from the past can affect a particular growth cycle. For example, a particular area 100 can have suffered from infections in previous years and these past infections still affect the probability to catch fungi in the current year or not.

However, such condition data from the past would belong to current condition data 202. (Historical condition data 201 is used in the training, not in the prediction phase).

Historical condition data 201 is directly or indirectly related to historical damage data 391 symbolized by black dot symbols. During training, the network receives historical condition data 201 and historical damage data 391 (cf. FIG. 5).

It is not necessary that historical condition data is derived from the particular geographic area 100. It can be obtained from other areas, such as from regions.

Historical condition data 201-1 has been obtained by monitoring the growth occurring in the past (for example, in the years 2018, 2019, 2020). It reflects the development of the plants during A, B and C) from spring to autumn of that years. Historical damage data 391 is available as annotations obtained at the end of cycles ABC (by an expert user, cf. FIG. 5, direct relation). At the end of the cycle (i.e., at C before harvest), experts identify the INCIDENCE and allocates a percentage (similar to the percentage illustrated in FIG. 1). The figure symbolizes different damage values by smaller or larger dots.

Historical condition data 201-2 represents crop rotation. The figure does not show annotations, but historical damage data 391 becomes available when data 201-2 is combined with other data. For example, data 201-1 shows historical condition data (for the growth cycle the year 2018) and shows that historical condition data could optionally be enhanced by information regarding the crop rotation before 2018. Assuming data 201-1/2018 standing for canola in 2018, the extended data could indicate the crops in 2015, 2016 and 2017 (not with all growth detail, but at least indicating the crop species).

Historical condition data 201-2′ represents crop rotation by a further example, for the previous two years (before the growth year). The example illustrates that data can be related to factors (to be processed by the network), for example as follows: (2019, 2020)=(canola, canola) leads to the factor “2”. (2019, 2020)=(other, canola) OR (canola, other) leads to the factor “1”. (2019, 2020)=(other, other) leads to the factor “0”.

Historical condition data 201-3 is an example environmental data for complete whole years (not including plant growth).

Since historical condition data is synchronized, historical annotations are applicable likewise. For example, historical data sets can count the days (or the weeks) from t_start_grow and t_harvest, as day #1 and day #X. But different particular calendar days would not matter. Day #1 can be 15 May 2019, or can be 10 May 2018, but in relative terms, it would be day #1.

Some overlap in time is possible. For example, current condition data 202-4 comprises data from the seasons before seed, but some part of historical data 201-1 can been collected during that past seasons (e.g., autumn 2020).

The description will turn to training next.

Computer in Training

FIG. 5 illustrates network 471 being trained. Once training has been completed, the network can operate as network 472, cf. FIG. 2.

Training data is a combination of historical condition data 201 and historical damage data 391. In terms of machine learning, the combination can be considered as the ground truth. Historical damage data 391 is given by expert user 191 who has inspected fields in reality, at the end of an historical stage C shortly before harvest. The expert does not have to inspect area 100 for that the computer will make the prediction. Historical damage data 391 is provided in form of expert annotations.

In an alternative, historical damage data 391 is provided in form of sensor readings (i.e., from sensors that identify damages). Exemplary sensors include image sensors, in combination with computers that identify the damages by processing the images.

By way of example, the figure shows a training data set with 4 time-series (historical condition data 201 for the years 2016, 2017, 2018, 2019) with 4 annotated damage quantities (i.e., 0, 10, 20, and 30% for these years, respectively). Historical condition data 201 is symbolized by referring to references 201-1 and 201-3 in FIG. 4. It is noted that some of data may not be applied for training (such as weather data in 201-3 for time-points after harvest, cf. 201-1).

The figure is much simplified by illustrating historical condition data 201 (and historical damage data 391) for 4 years only. Whenever possible, data from further years should be used (e.g., 10 years). Of course, the number of available data sets is rising with every year. As indicated by the references within the arrows, historical condition data 201 is not only data regarding historical ABC cycles (cf. 201-1 in FIG. 4) but also environmental data (cf. 201-3 in FIG. 4). Crop rotation data can be added optionally.

### Implementation Example

FIGS. 6-7 illustrates simplified code for an implementation example by that neural network 471/472 is obtained by configuring parameters of a commercially available tool, such SAS ENTERPRISE MINER (available from SAS Institute Inc., located in Cary, North Carolina USA).

The tool operates like a framework in that performs the operation of the network.

In the figures, two-digit numbers identify code lines. Occasionally, the figures skip some lines and indicate them by ellipsis.

As in line 01, the so-called “HPNEURAL Procedure” of the tool implements a multilayer perceptron (MLP). In other words, the statement indicates the ANN is provided in the MLP architecture. The parameters are configured by a first statement (for training, FIG. 6) and a second statement (for scoring, FIG. 7).

While the tool can operate in a single-machine mode or in a distributed mode, the description refers to single-machine mode. The skilled person can rewrite the statement for distribution mode, as explained in the SAS documentation.

As mentioned above, the skilled person can arrange data storage and other data logistics. For example, in line 01, statements like “data=TRAIN” identify historical condition data 201, and “data=TEST” identifies current condition data 202.

In a further example, line 03 identifies meta data (by the “id” notation): The variable “year” identifies the calendar year in that the prediction is performed (cf. 2021 in FIG. 4). Other data is linked to calendar weeks. The variable “prov” identifies a region in that geographic area 100 is located. This is convenient (for farmer user 192) but not required for the calculation. The region can be an administrative division such as a province (in Canada), a Bundesland (in Germany), a département (in France) or the like. The variable could also identify the above-mentioned arbitrary grid. The variable “ccsuid” identifies the particular geographic area 100 for that the historical condition data 201 and/or current condition data 202 is applicable, and for that the damage is being predicted. The example uses a simple identification number in combination with geographic latitude and longitude (of a center point). More in particular, CCSUID can represent a Consolidated Census Sub-Division, in Canada, but the variable is just convenient as an identifying label.

Such metadata is however not related to the operation of the network.

Data formats are defined according to common conventions. For example, the notation “/level=interval” stands for a variable in the closed interval [0,100] (i.e., including both limit points) and “/level=nominal” stands for real numbers.

In the following, the description refers to some of the above-mentioned input values.

The implementation example is presented here for the canola/Sclerotinia pair.

Training (First Statement)

FIG. 6 illustrates the simplified code for the implementation example by that the neural network performs training.

The code in 01 further identifies a file “TRAIN” as the input (historical condition data 201, cf. FIG. 4).

The code in line 02 “target . . . ” points to historical damage data 391 as in FIG. 5 right side, FIG. 4 dot symbols. In other words, this code links the tool to the annotations by the expert user. The code example also indicates the output range, here as a real number in the closed interval [−1,1].

The code starting at line 03 identifies historical condition data 201 (at the input of network 471 under training) with more detail.
scl_inc_mn (i.e., mean Sclerotinia incidence for all historical years)
scleroinc_prev_yr points to real damage data from the previous year (not predicted damage data 302, but to data that represents real damage).
use_int_mn points to use data, such as to the application of fungicide (t_application for situations in that fungicides had been applied previously, before t_run, optionally available)
use_int_prev_yr points to historical application data (cf. 201-1 for the year 2020).
canyrs_score points to historical condition data for crop rotation. In the implementation example, the data is applicable for the previous two years (cf. years 2019 and 2020 as explained with factors in connections with 201-2′ in FIG. 4. The factors 1 and 2 are assigned to weights 4 and 7, respectively.

The data can be defined for a particular area, or for a particular region.

The code from line 08 points to historical condition data in the form of time-series, for example to the maximal air temperature from week 18 to week 35. There are other weather and other environmental data time-series (such as for minimal temperature, relative humidity, wind speed, soil moisture), plant data (biomass), and other parameters mentioned above. Although not illustrated here in the code, there are also time-series in diff-mode (preprocessed to differential values, as explained above).

The code “partition” instructs the tool to partition the training data set into 70% training and 30% validation data.

The code “hidden 3; hidden 3” instructs the tool to implement the perceptron with multiple layers. As the keyword is repeated, the tool applies two layers. Each layer has 3 neurons. For convenience, FIG. 6 also illustrates a schematic diagram of the network.

Simplified, each neuron in the input layer of the perceptron receives data from P inputs. The number of P corresponds to the overall number of elements in all time-series, as well as data that is not given as time-series. For example, there are 10 parameters in time-series (e.g., temperature, biomass etc., including differential parameters) with data for 20 weeks, plus some parameters without time-series (e.g., crop rotation), leading to P=220 (approximately). There would be 3 neurons at the input. As the tool defines the model according to the available (training) data, the exact P numbers are not relevant.

The code “train outmodel=model_neural_network” lets the tool generate a file (or other datastructure) that stores the network parameters that are obtained for the perceptron by training. In other words, “train” stands for the operation mode.

For simplicity, the code example assumes operation according to default settings of the tool. For example, training the network provides results with the default number of 50 iterations.

Scoring (Second Statement)

FIG. 7 illustrates the simplified code for the implementation example by that neural network performs prediction (or “scoring”).

The code in line 01 further identifies current condition data 202 (for a particular area 100).

The code in line 02 indicates the output, that is predicted damage data (cf. FIG. 2, 302). This has the same dimension as the training set (cf. the annotations in FIG. 5), here in percentages.

The code in line 03 identifies the particular data for the particular area 100, as explained above.

The code in line 04 identifies the operation mode “scoring” (i.e., predicting) by using the earlier obtained file with the parameters. The term “out=scored_nn” stands for the name of the file in that the predicted damage data becomes available.

The code in line 04 also indicates the file name into that the incidence value should be written: “out=scored_nn.

Network Topology

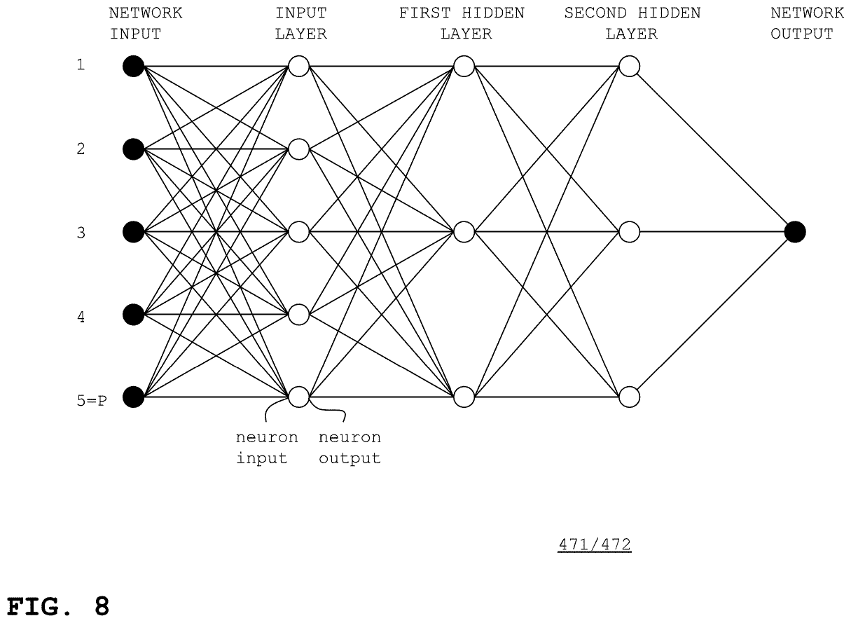

FIG. 8 illustrates a simplified topology for the neural network 471/472 of FIGS. 6-7. The figure illustrates network inputs and network output by black nodes, and illustrates the neurons by white nodes, with neuron inputs to the left and neuron outputs to the right. Vertically illustrated neurons belong to a layer.

The edges (between the nodes) stand for weighted connections (weights obtained during training). In this illustration, data flows from left to right.

Neural network 471/472 has P network inputs. To simplify the illustration, the figure does not show P=220 inputs (or other relatively large number), but keeps the number at P=5. The input layer has P neurons (corresponding to the number of inputs). The input layer is fully connected to the network inputs (each network input having an edge to each neuron of the input layer, with P2 edges).

The first hidden layer and the second hidden layer each have 3 neurons (cf. the statement “hidden 3” in the code example). The P neurons of the input layer all connect to the 3 neurons of the first hidden layer. The 3 neurons of the first input layer connect to the 3 neurons of the second hidden layer.

The output collects the incidence value (cf. FIG. 1, the percentage).

Options

Network 472 would perform prediction for the particular area 100, but can repeat the calculation for other areas. As a result, the farmer user (cf. FIG. 2) could view a map with the areas (such as a map of the region). More in detail, the farmer could see predicted damage data for each CCSUID (in Canada).

Alternative Implementations

Having explained structure and function of network 471/472 in view of the SAS tool is convenient. However, other implementations are possible as well. The network could be implemented on a different machine learning platform and could use code libraries or frameworks that are specialized for neural networks.

An example is given in the following: Input data is normalized with the MinMaxScaler transform option of a preprocessing algorithm from the scikit-learn Python module. This data transformation ensures that all input data are scaled uniformly. A multi-layer perceptron supervised learning neural network Python model was implemented with the MLP Regressor algorithm (from scikit-learn module). Two forms of the preceding model had been implemented: (i) a perceptron neural network model with one hidden layer having a hidden unit size of 50 and (ii) another with two hidden layers having a hidden unit size of 100. Default settings were used for other model parameters. Details can be consulted under https://scikit-learn.org/stable/modules/generated/sklearn.neural_network.MLPRegressor.html#sklearn.neural_network.MLPRegressor.

In addition to these two sets of predictions, Sclerotinia incidence was predicted with a XGBoost Python model implemented with the XGBRegressor algorithm from the scikit-learn module. A perceptron neural network model with one hidden layer having a hidden unit size of 50 and another with two hidden layers having a hidden unit size of 100. The XGBoost model was implement with default settings were used for other model parameters. Details for such models are available under: https://xgboost.readthedocs.io/en/latest/python/python_api.html.

The current form of the Sclerotinia advisor model generates three sets of Sclerotinia incidence predictions.

Cardinality Differences in Time-Series

As explained above, some of historical condition data 201 and some of current condition data 202 is available in form of time-series. While historical condition data 201 is usually available for a relatively long interval between t_start_monitor (or t_start_grow) and t_harvest, current condition data 202 can only be available for relatively short intervals ending shortly before t_run at the latest.

Controlling the Application of Fungicides

As explained already, the prediction of damages to the crop plants allows the farmers to make informative decisions to apply fungicides or not.

Based on the data (i.e., damage data, condition data) the computer (cf. 400 in FIG. 2) can optionally be equipped with further modules. For example, a recommendation module can process damage and condition data to obtain recommendations, such as a recommendation to apply fungicides (or not), a recommendation to selectively apply particular fungicides (e.g., a “weak” one for minor damages, a “strong” one for major damages), a recommendation to apply a particular fungicide in a particular amount or concentration, or a recommendation to take other measures.

Optionally, the recommendation module can be updated to a control unit for a sprayer or other fungicide distribution hardware. In such scenarios, the computer (and the further modules) would (semi-)automatically control the application of fungicides.

Alternative Timing

The description has introduced plant data in view of time: data comprises a species identifier of the particular species of crop plants currently being grown or intended for growing. FIG. 2 illustrates the first case: t_start_grow is prior to t_run. The computer makes the damage prediction for plants that are already growing.

In a second case, the relation would be reversed. At t_run, the computer would make a prediction and based on the prediction, the farmer would decide to seed the plants (or even not to seed them), to apply fungicides early (even prior to seed) etc. Or in other words, there is an intention to grow particular plants (e.g., Canola), and the prediction would dictate the circumstances (growing by simultaneously applying fungicides, not growing at all, and so on). Alternatively, the method can be performed prior to t_start_growth, and the prediction would still applicable for a time shortly before harvest. The farmer may decide not the grow the plant at all.

Input Data Importance

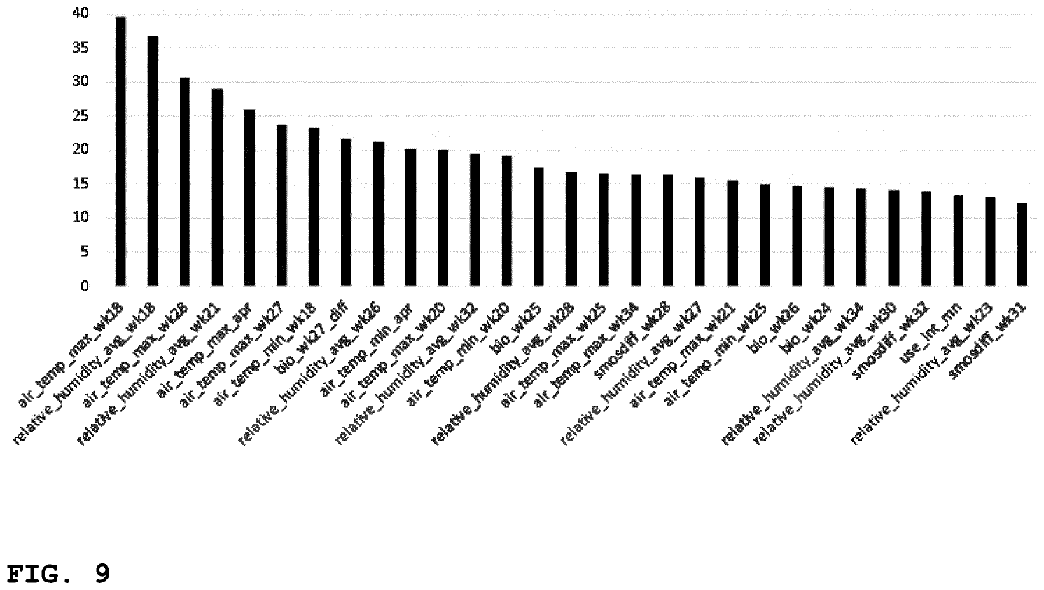

FIG. 9 illustrates an overview to different importance for different current condition data. It may occur that current condition data is not available completely for all parameters, at least not at every point in time. Nevertheless, the computer can perform the prediction, even if data is not available with all parameters that have been discussed above. The figure illustrates importance values for exemplary condition data, calculated by a computer. The absolute importance values do not matter, but the relative difference is pointed out: For example, air temperature from week 18 has more importance than the air temperature from week 27. Data types and importance values are ordered with decreasing importance from left to right.

As already mentioned, environmental data can comprise air temperature data (in the figure illustrated as maximal temperature) with different importance for different weeks. As temperature values are substantially available for any day or week, such data is supplied to the network (whenever available).

Regarding other environment data, there is no need to process of all that. Environmental data can be at least one of: soil moisture data (SMOS), relative air humidity data, wind speed data and precipitation data. There can be combinations (pairs such as for example, soil moisture and humidity, or wind and precipitation, or other combinations). Combination of two or more data types increase the prediction accuracy.

As mentioned, plant data can comprise biomass data (BIO in the figure). Since the plants are growing, biomass data would not be available at the beginning of the season. In that sense, such data can be missing, but the network can nevertheless obtain predictions.

There is a set of 3 data types (for soil moisture, relative air humidity and biomass) that in combination (all 3) provide relatively high prediction accuracy. Permutations (2 of 3, such as moisture/humidity, humidity/biomass, or moisture/biomass) lead to accurate results as well. It would also be possible just to use one of these 3 data types.

Again to take the Canola example (for Canada), during the winter months (e.g., prior to April each year), data regarding the past (historical) season for scleroinc incidence and use intensity (of fungicides) is available. The same availability applies for the identification of crop plant (e.g., consecutive canola growth). The computer could start performing the method to predict damage with such initial data, at the cost of having reduced accuracy of the result (as explained).

In later performances of the method, the network can begin to ingest weather data (eventually limited to “temperature”, “precipitation”, or “wind”, or to combinations). Predictions could begin when this data is available, but potentially lead to results with better accuracy.

SMOS (soil moisture) data and relative humidity data ingestion can begin in April, but the network may not use this data until May. Biomass (obtained via MODIS) data can be ingested earlier as well, but the model may begin to process this data mid-May, this is the time when widespread canola biomass accumulation is expected to begin. From April 1 on, additional input data (weather with relative humidity RH beginning May 1, SMOS beginning May 1, as well as biomass (MODIS, beginning mid-May) are available to the network on a week time interval Δt until the end of August.

This explanation is just provided as an example. More in general, receiving current condition data in form of time-series can optionally comprise to receive data for environmental parameters with the parameters selected according to the progress of the plant growth, as explained for the different data types.

Computer

The physical location of computer 400 is not relevant, it can be located on a server farm (“cloud computing”).

Computer 400 can be considered as a computer system comprising a plurality of function modules which, when executed by the computer system, perform the steps of the computer-implemented method.

FIG. 9 illustrates an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Generic computer device may 900 correspond to computers 201/202 of FIGS. 1-2. Computing device 950 is intended to represent various forms of mobile devices, such as personal digital assistants, cellular telephones, smart phones, and other similar computing devices. For example, computing device 950 may include the data storage components and/or processing components of devices as shown in FIG. 1. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk. The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

### REFERENCES

100 geographic area
110 crop plant
115 crop plant damaged by fungi
120/125 fungi/spores
130 fungicide
140 surplus fungicide
191/192 expert/farmer user
201 historical condition data
202 current condition data
302 predicted damage data
391 historical damage data
400 computer
471 network (being trained)
472 network (trained earlier)
A, B, C growth stages,
ABC stage sequence, growth cycle
t time-points
T time intervals

1. A computer-implemented method to predict damage of crop plants (110) of a particular species by Sclerotinia sp. fungi (120), wherein the crop plants (110) grow in a particular geographic area (100), the method comprising:
receiving current condition data (202) in form of time-series, the current condition data (202) relating to the particular geographic area (100) and being collected during a monitor interval (T_MONITOR) from a start time point (t_start_monitor) to a present time point (t_run), wherein the current condition data (202) comprise plant data that describes the plants (110) growing or to be grown in the particular geographic area (100) by a species identifier of the particular species of crop plants (110), the number of occurrences of the crop plant in a previous interval; and environmental data that describe the environment of the particular geographic area (100); and
processing the current condition data (202) by an artificial neural network (472), to provide predicted damage data (302), the artificial neural network (472) obtainable by previously training it by processing historical condition data (201) in the form of time-series in combination with historical damage data (391) in form of expert annotations, or in combination with historical damage data in form of sensor readings.

2. The method according to claim 1, wherein the historic condition data (201) comprises crop cycle data.

3. The method according to claim 1, wherein the environment data further comprises at least one of: soil moisture data, relative air humidity data, wind speed data, and precipitation data.

4. The method according to claim 1, wherein receiving current condition data comprises to receive the number of occurrences of the crop plant in a previous interval together with an identification of occurrences of crop plants for different species.

5. The method according to claim 1, wherein receiving current condition data comprises to receive biomass data for the crop plants (110) currently being grown.

6. The method according to claim 1, wherein the crop plants (110) are selected from the group consisting of: Brassica napus Canola, Helianthus annuus, Fabaceae sp., Glycine max, Lens culinaris, and Pisum sativum.

7. The method according to claim 1, wherein the artificial neural network is a model that is a multilayer perceptron.

8. The method according to claim 1, wherein predicted damage data (302) is provided as the ratio between the number (Z) of crop plants (115) expected to be infected by that Sclerotinia sp. fungi (120) in the particular geographic area (100) shortly before harvest (t_harvest) over the number (Y) of crop plants (110) grown in the particular geographic area (100) during a growth cycle (ABC).

9. The method according to claim 1, wherein receiving current condition data (202) in form of time-series comprises to receive the time-series with equidistant time-divisions that have a value between 3 and 10 days.

10. The method according to claim 9, wherein receiving current condition data (202) in form of time-series, comprises to also receive the time-series in the first order difference.

11. The method according to claim 1, wherein receiving current condition data (202) in form of time-series further comprises to receive real damage data that describe damage that has really occurred.

12. The method according to claim 1, wherein receiving current condition data (202) in form of time-series further comprises to receive use data that describe the use intensity of a particular chemical compound on the particular geographic area (100).

13. The method according to claim 1, wherein receiving current condition data (202) in form of time-series comprises to receive data for environmental parameters with the parameters selected according to the progress of the plant growth.

14. A non-transitory computer-readable medium having instructions encoded thereon that, when loaded into a memory of a computer and being executed by at least one processor of the computer, cause the computer to perform the steps of a method according to claim 1.

15. A computer system comprising at least one processor configured to perform the steps of the computer-implemented method according to claim 1.
